(19) United States
(12) Patent Application Publication
(10) Pub. No.: US 2021/0323001 A1
(43) Pub. Date: Oct. 21, 2021

(54) COLD WATER MINERAL FLOTATION COLLECTOR BLEND

(71) Applicant: Canada Fluorspar (NL), Inc., St. Lawrence (CA)

(72) Inventor: Norman Wilson, St. Lawrence (CA)

(73) Assignee: Canada Fluorspar (NL), Inc., St. Lawrence (CA)

(21) Appl. No.: 17/232,468

(22) Filed: Apr. 16, 2021

Related U.S. Application Data
(60) Provisional application No. 63/011,952, filed on Apr. 17, 2020.

(51) Int. Cl. B03D 1/006

(52) U.S. Cl. CPC B03D 1/006; B03D 2201/02

(57) ABSTRACT

A novel reagent blend and a method by which a fatty acid collector can be used at temperatures below which the fatty acid normally begins to solidify. The reagent blend may comprise fatty acid, an emulsifying reagent, and glycol ether. The emulsifying reagent may comprise 5% of the reagent blend, while the glycol ether may comprise 1% of the reagent blend. The reagent blend may be used for mineral flotation without the addition of heat.

### CROSS REFERENCE

This application is based on and claims priority to U.S. Provisional Patent Application Ser. No. 63/011,952, filed Apr. 17, 2020, which is incorporated herein in its entirety by reference.

### BACKGROUND OF THE INVENTION

### Field of the Invention

This invention relates generally to mineral flotation, and more particularly, but not by way of limitation, to a novel reagent blend and a method by which a fatty acid collector can be used at temperatures below which it normally begins to solidify.

### Description of the Related Art

Many non-metallic mineral flotation mills rely on the use of a fatty acid to render the desired mineral hydrophobic. Since mineral-collector attachment occurs more efficiently at elevated temperatures, at least above the temperature at which the fatty acid begins to solidify, many processes rely on some form of heat during conditioning.

In the cold-water flotation of non-metallic minerals, recovery drops as process water temperature falls. This is as a result of poor collector-to-mineral bonding. Some laboratory studies have been conducted to find a non-metallic mineral collector that can be used in cold water. Most have used a combination of a fatty acid with some type of emulsifier; however, none have been successful.

The drop in recovery associated with a reduction in pulp temperature is particularly problematic in cold climates, where mineral recovery is always worse in winter than in summer.

Based on the foregoing, it is desirable to provide a novel reagent blend that suppresses the solidification temperature of fatty acid.

It is further desirable for the reagent to allow mills, especially in cold climates, to use fatty acid collectors at a reduced cost.

### SUMMARY OF THE INVENTION

In general, in a first aspect, the invention relates to a reagent blend for use in mineral flotation, the reagent blend comprising: a fatty acid; an emulsifying reagent; and glycol ether. The emulsifying reagent may comprise 5% by weight of the reagent blend, while the glycol ether may comprise 1% by weight of the reagent blend.

In a second aspect, the invention relates to a method of producing a reagent blend for use in mineral flotation, the method comprising: adding 5% emulsifying reagent to fatty acid; mixing; adding 1% glycol ether; and mixing to produce a solution. The emulsifying reagent and the fatty acid may both be above a temperature at which solids start to leave the solution.

In a third aspect, the invention relates to a method of mineral flotation, the method comprising using a reagent blend, where the reagent blend comprises: a fatty acid; an emulsifying reagent; and glycol ether. The method may not comprise applying heat. The emulsifying reagent may comprise 5% by weight of the reagent blend, and the glycol ether may comprise 1% by weight of the reagent blend.

### DETAILED DESCRIPTION OF THE INVENTION

The devices and methods discussed herein are merely illustrative of specific manners in which to make and use this invention and are not to be interpreted as limiting in scope.

While the devices and methods have been described with a certain degree of particularity, it is to be noted that many modifications may be made in the details of the construction and the arrangement of the devices and components without departing from the spirit and scope of this disclosure. It is understood that the devices and methods are not limited to the embodiments set forth herein for purposes of exemplification.

In general, in a first aspect, the invention relates to a novel reagent blend and a method by which a fatty acid collector can be used at temperatures below which it normally begins to solidify. The reagent blend may, when used in a specific proportion, suppress the solidification temperature of the fatty acid, thus negating the use of heat. This may allow mills, especially in cold climates, to use fatty acid collectors at a reduced cost.

The reagent blend may comprise three components: a fatty acid; an emulsifying reagent; and glycol ether. The fatty acid and the emulsifier may be above the temperature at which solids start to leave the solution. The reagent blend may be made by adding five percent emulsifier to the fatty acid and mixing well. One percent glycol ether may then be added to the mix and again blended. Without the addition of the glycol ether, the fatty acid and emulsifier combination may not have the desired effect.

The fatty acid may be any desired fatty acid. Likewise, any desired emulsifying reagent may be used. In particular, during testing, PM950 supplied by Axis House was used as the emulsifying reagent.

In a mill that typically must apply heat to the system to use the fatty acid, the use of the reagent blend may allow mineral recovery without the application of heat. In a mill that typically does not use heat, the use of the reagent blend may result in an increase in mineral recovery. In cold climates that typically experience a drop in recovery during winter compared to summer, use of the reagent blend may equalize seasonal recovery.

### EXAMPLE

The reagent blend of the present invention was tested using Sylfat FA2 fatty acid collector. The following are the results of that testing.

FA2 has a cloud point of around 14° C. as a result of its saturated fat content. Fats are composed of fatty acids and glycerin; those having one or more double bonds in carbon-carbon links are referred to as unsaturated fatty acids and examples include oleic acid, linoleic acid, and linolenic acid. Sylfat FA2, tall oil fatty acid (TOFA), is one that combines a long-chain (C18) of relatively high unsaturation with the acid functionality of a carboxyl group (—COOH).

The cloud point of a mixture of fatty acids decreases slowly as the unsaturated fatty acid content is increased. The cold resistance of a fat can be improved if it is inhibited from undergoing crystal growth as it cools. If a chemical can be found that dissolves the saturated component that first crystalizes from fatty acid on cooling, and itself has a very low freezing point, it will lower the freezing point of the blended reagent. This reagent must not have a negative effect on the properties of the original fatty acid. One such chemical with a freezing point well below 0° C. is glycol ether, which is the major constituent of W31 frother.

Testing has shown that a solution of 0.5% W31 in emulsified FA2 reduces the cloud point from 14° C. to 7° C., while 1% W31 reduces the cloud point to 1° C.

Four lab tests were conducted, one at ambient, a second with the feed water reduced to 6° C., and two with the feed water temperature reduced to 3° C. The collector used in the cold-water tests was a blend of 95% fatty acid with 5% emulsifier, to which was added 1% W31.

### Test 1

This was a baseline, standard ambient test, which gave a concentrate grade of 98.5% CaF2, 0.46% SiO2, and an open circuit recovery of 80.5%.

### Test 2

The first cold-water test was conditioned at 7° C. and cleaned at 10° C., giving a concentrate grade of 99% CaF2 and 0.47% SiO2 at an open circuit recovery of 78.9%. Since this was encouraging, it was decided to conduct a third test using the same reagents but cleaning at 3° C. The lower temperature had to be tested to ensure the oleate-fluorspar bond was strong enough to withstand the mill cold-water cleaner sprays.

### Test 3

The colder water did affect flotation with significant over-depression. As a result, this test was terminated at the second cleaner stage. Back calculation gives a first cleaner recovery of only 61.6% at a grade of 97.6% CaF2. A fourth test was therefore necessary using reduced depressants.

### Test 4

In this test, fluorspar was conditioned at 7° C. and floated in the cleaners at 3° C. Depressants used in this test were half that used at ambient. The resulting concentrate assayed at excess of 99% CaF2, with a silica of 0.45% for an open circuit recovery of 83.9%. These results are considered exceptional for such cold water.

### Discussion

It is often the case with cold water flotation that a thick immobile froth results due to excess collector being required. This gives a high froth factor and difficulty is encountered in breaking down the froth in the launders with subsequent pumping problems. With this new reagent, no such difficulties were encountered with an open, well drained froth forming throughout. It should be noted that clean water was used in the lab work.

Whereas, the devices and methods have been described in relation to the drawings and claims, it should be understood that other and further modifications, apart from those shown or suggested herein, may be made within the spirit and scope of this invention.

What is claimed is:

1. A reagent blend for use in mineral flotation, the reagent blend comprising:
a fatty acid;
an emulsifying reagent; and
glycol ether.

2. The reagent blend of claim 1 where the emulsifying reagent comprises 5% by weight of the reagent blend.

3. The reagent blend of claim 1 where the glycol ether comprises 1% by weight of the reagent blend.

4. A method of producing a reagent blend for use in mineral flotation, the method comprising:
adding 5% emulsifying reagent to fatty acid;
mixing;
adding 1% glycol ether; and
mixing to produce a solution.

5. The method of claim 4 where the emulsifying reagent and the fatty acid are both above a temperature at which solids start to leave the solution.

6. A method of mineral flotation, the method comprising using a reagent blend, where the reagent blend comprises:
a fatty acid;
an emulsifying reagent; and
glycol ether.

7. The method of claim 6 where the method does not comprise applying heat.

8. The method of claim 6 where the emulsifying reagent comprises 5% by weight of the reagent blend.

9. The method of claim 6 where the glycol ether comprises 1% by weight of the reagent blend.
